(19) United States
(12) Patent Application Publication
(10) Pub. No.: US 2022/0332125 A1
(43) Pub. Date: Oct. 20, 2022

(54) CONTROL OF PUMP GENERATORS AND DROP GENERATORS

(71) Applicant: Hewlett-Packard Development Company, L.P., Spring (US)

(72) Inventor: Craig Olbrich, Corvallis, OR (US)

(73) Assignee: Hewlett-Packard Development Company, L.P., Spring, TX (US)

(21) Appl. No.: 17/765,011

(22) PCT Filed: Oct. 17, 2019
(86) PCT No.: PCT/US2019/056749

§ 371 Date: Mar. 30, 2022

(51) Int. Cl. B41J 2/19; B41J 2/175; B41J 2/14

(52) U.S. Cl. CPC B41J 2/19; B41J 2/175; B41J 2/1404; B41J 2202/12

(57) ABSTRACT

According to examples, an apparatus may include a pump generator having a first resistance level and being positioned within a fluid circulation channel and a drop generator having a second resistance level and being positioned within a fluid ejection chamber. The apparatus may also include a control line connected to both the pump generator and the drop generator and a controller. The controller may output, at a first time, a first signal having a first pulse duration to the control line, the first signal to cause fluid in the fluid circulation channel to reach or exceed a first temperature and fluid in the fluid ejection chamber to remain below the first temperature and may output, at a second time, a second signal having a second pulse duration, the second signal to cause fluid in the fluid circulation channel and the fluid ejection chamber to reach or exceed the first temperature.

### BACKGROUND

Fluid ejection devices, such as printheads in printing systems, may use thermal resistors or piezoelectric material membranes as actuators within fluidic chambers to eject fluid drops (e.g., ink) from nozzles, such that, properly sequenced ejection of the fluid drops from the nozzles may cause characters or other images to be printed on a print medium as the printhead and the print medium move relative to each other. In some devices, a printhead may eject fluid drops from a nozzle by passing electrical current through a heating element to generate heat and vaporize a small portion of the fluid within a fluid ejection chamber. In other types of devices, a piezoelectric material actuator may generate pressure pulses that may force fluid drops out of a nozzle.

### BRIEF DESCRIPTION OF THE DRAWINGS

Features of the present disclosure are illustrated by way of example and not limited in the following figure(s), in which like numerals indicate like elements, in which:

FIG. 1 depicts a block diagram of an example apparatus that may include a pump generator that may cause a portion of fluid to be circulated in a fluid circulation channel and a drop generator that may cause a portion of the fluid to be ejected from a fluid ejection chamber;

FIG. 2 shows a schematic plan view of a portion of an example fluid ejection device that may include the pump generator and the drop generator of the apparatus depicted in FIG. 1;

FIG. 3 depicts an enlarged cross-sectional side view of a portion of the example fluid ejection device depicted in FIG. 2;

FIG. 4 shows a block diagram of an example apparatus that may include a pump generator that may cause a portion of fluid to be circulated in a fluid circulation channel and a drop generator that may cause a portion of the fluid to be ejected from a fluid ejection chamber;

FIG. 5 shows a block diagram of an example printing system that may include either of the apparatuses depicted in FIGS. 1 and 4; and

FIG. 6 depicts a flow diagram of an example method for selectively controlling the formation of a drive bubble in a fluid circulation channel or a drive bubble in the fluid circulation channel and a drive bubble in the fluid ejection chamber.

### DETAILED DESCRIPTION

Disclosed herein are apparatuses, fluid ejection devices, and methods for controlling a pump generator and a drop generator in the fluid ejection devices via a single control line connected to both the pump generator and the drop generator. As discussed herein, the pump generator may be housed in a fluid circulation channel and the drop generator 106 may be housed in a fluid ejection chamber, in which the fluid ejection chamber may include a nozzle through which a drop of fluid may be ejected. The fluid circulation channel may be in fluid communication with the fluid ejection chamber such that a fluid may flow between and through the fluid circulation channel and the fluid ejection chamber as a drive bubble or multiple drive bubbles are formed in the fluid circulation channel and/or the fluid ejection chamber. The fluid circulation channel and the fluid ejection chamber may also be in fluid communication with a fluid feed slot such that fluid may circulate with fluid in the fluid feed slot, for instance, to refresh the fluid in the fluid circulation channel and the fluid ejection chamber.

The apparatuses disclosed herein may include a controller that may control the circulation/ejection of the fluid through application of a first signal or a second signal through the control line. That is, the first signal may correspond to a current having a first pulse duration and the second signal may correspond to a current having a second pulse duration. The pump generator, the drop generator, and/or other components, e.g., a resistor in series with the drop generator, portions of a dividing layer, and/or the like, may have properties that may cause bubble formation in the fluid circulation channel and the fluid ejection chamber to occur differently based on the output of the first signal and the second signal.

For instance, output of the first signal may cause fluid in the fluid circulation channel to reach or exceed a first temperature, e.g., a nucleation temperature of the fluid, and fluid in the fluid ejection chamber to remain below the first temperature. Thus, for instance, the first signal may cause a drive bubble to be formed in the fluid contained in the fluid circulation channel without causing a drive bubble to be formed in the fluid contained in the fluid ejection chamber. However, output of the second signal may cause fluid in the fluid circulation channel and the fluid ejection chamber to reach or exceed the first temperature. Thus, for instance, the second signal may cause drive bubbles to be formed in the fluid contained in both the fluid circulation channel and the fluid ejection chamber.

Through implementation of the features of the present disclosure, a controller may control both a pump generator and a drop generator in an apparatus, e.g., a printhead, through output of signals across a common control line to both the pump generator and the drop generator. The use of a common control line for both the pump generator and the drop generator instead of using individual control lines may result in a reduced number of components as well as a reduction in a number of manufacturing steps that may be employed to fabricate the apparatus.

Throughout the present disclosure, the terms “a” and “an” are intended to denote at least one of a particular element. As used herein, the term “includes” means includes but not limited to, the term “including” means including but not limited to. The term “based on” means based at least in part on.

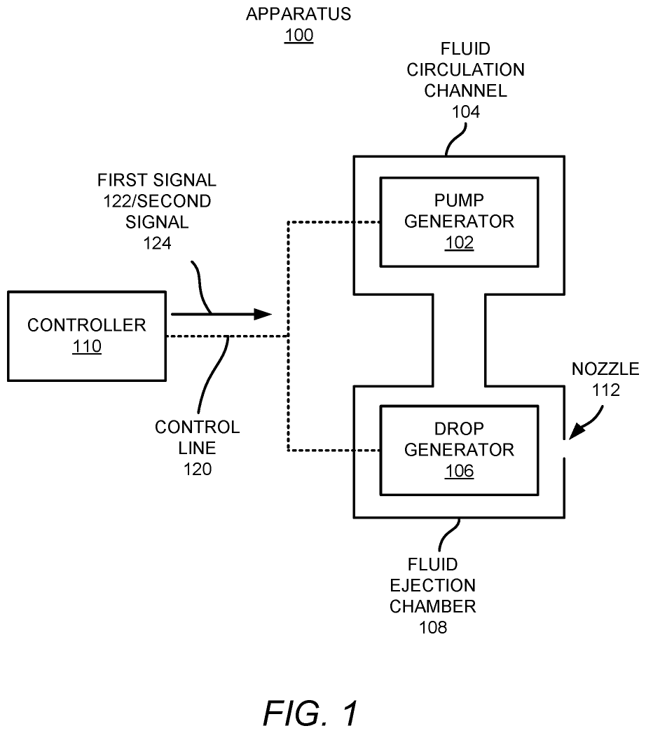

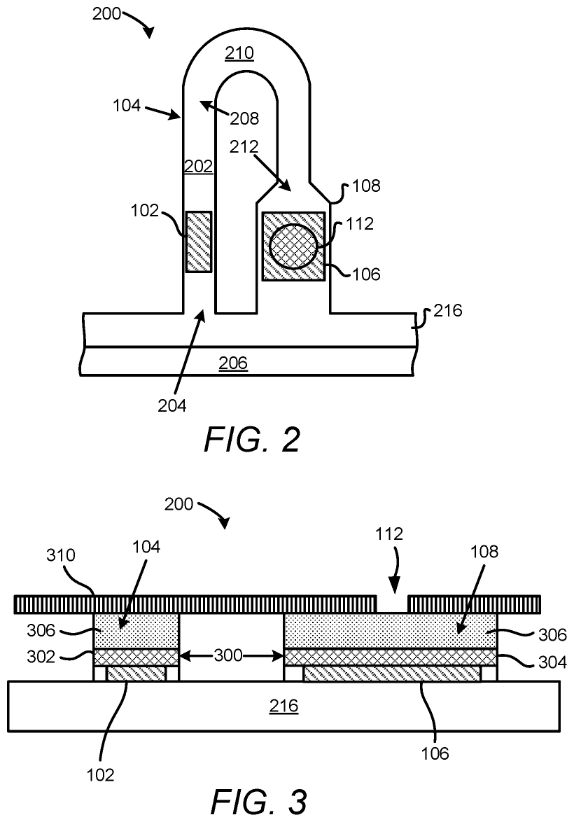

Reference is first made to FIGS. 1 and 2. FIG. 1 shows a block diagram of an example apparatus 100 that may include a pump generator 102 that may cause a portion of fluid to be circulated in a fluid circulation channel 104 and a drop generator 106 that may cause a portion of the fluid to be ejected from a fluid ejection chamber 108. FIG. 2 shows a schematic plan view of a portion of an example fluid ejection device 200 that may include the pump generator 102 and the drop generator 106 of the apparatus 100 depicted in FIG. 1. It should be understood that the example apparatus 100 depicted in FIG. 1 and the example fluid ejection device 200 depicted in FIG. 2 may include additional features and that some of the features described herein may be removed and/or modified without departing from the scopes of the apparatus 100 and/or the fluid ejection device 200.

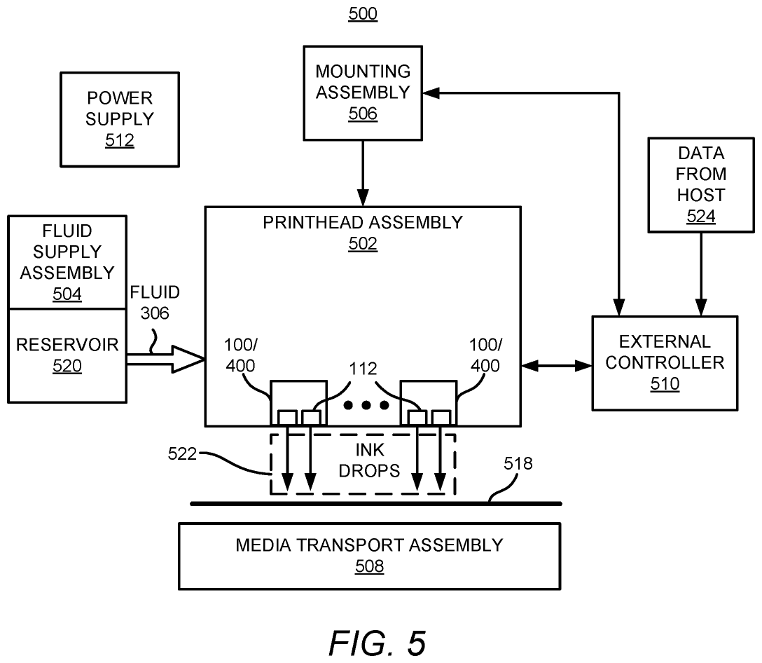

The apparatus 100 may include the fluid ejection device 200. Particularly, the fluid ejection device 200 may include the pump generator 102, the fluid circulation channel 104, the drop generator 106, and the fluid ejection chamber 108. According to examples, the apparatus 100 (and the fluid ejection device 200) may be or may be part of a printhead that may be implemented in a printing apparatus (see FIG. 5) to eject a fluid, e.g., printing fluid, ink, or the like, through a nozzle 112 in the fluid ejection chamber 108 onto a medium (see FIG. 5) to cause characters and/or other images to be printed onto the medium. Although not shown, the fluid ejection device 200 may include a plurality of sections that may similarly be configured to the section shown in FIG. 2 such that multiple drops of a fluid may be ejected through multiple nozzles in the printhead.

As shown in FIG. 2, the fluid circulation channel 104 may include a channel section 202 that is open to and in fluid communication at one end 204 with a fluid feed slot 206. The fluid feed slot 206 may provide a supply of fluid to the fluid circulation channel 104 and the fluid ejection chamber 108. The channel section 202 may also open to and may be in fluid communication at an opposite end 208 to a circulation loop 210. The circulation loop 210 may further open to and be in fluid communication to an end 212 of the fluid ejection chamber 108. The circulation loop 210 be U-shaped channel, although in other examples, the circulation loop 210 may have other shapes. According to examples, the fluid circulation channel 104 may have a substantially constant width throughout the channel section 202 and the circulation loop 210. That is, for instance, the width of the fluid circulation channel 104 may be within a range of deviation that is less than about 10% of an average width of the fluid circulation channel 104 across the channel section 202 and the circulation loop 210.

The fluid ejection chamber 108, the drop generator 106, the fluid circulation channel 104, and the pump generator 102 may be formed on a substrate 216. The fluid feed slot 206 may also be formed on the substrate 216. The substrate 216 may be formed, for example, of silicon, glass, a stable polymer, and/or the like. According to examples, a plurality of portions similar to the portion depicted in FIG. 2 may be provided along the substrate 216.

In one example, the fluid ejection chamber 108 may be formed in or defined by a barrier layer (not shown) provided on the substrate 216, such that the fluid ejection chamber 108 may provide a “well” in the barrier layer. The barrier layer may be formed, for example, of a photoimageable epoxy resin, such as SUB. According to an example, a nozzle or orifice layer (not shown) may be formed or extended over the barrier layer such that a nozzle opening or orifice 112 formed in the orifice layer may communicate with the fluid ejection chamber 108. The nozzle opening or orifice (which is also referenced herein as a nozzle) 112 may be of a circular, non-circular, or other shape.

The drop generator 106 may be a device that may cause fluid drops to be ejected through the nozzle 112. Examples of suitable drop generators 106 may include thermal resistors and piezoelectric actuators. A thermal resistor may be formed on a surface of a substrate 216 and may include a thin-film stack including an oxide layer, a metal layer, and a passivation layer such that, when activated beyond a certain level, heat from the thermal resistor may vaporize fluid in the fluid ejection chamber 108, thereby causing a bubble that may eject a drop of fluid through the nozzle 112. A piezoelectric actuator may include a piezoelectric material provided on a moveable membrane communicated with the fluid ejection chamber 108 such that, when activated beyond a certain level, may cause deflection of the membrane relative to the fluid ejection chamber 108, thereby generating a pressure pulse that may eject a drop of fluid through the nozzle 112.

The pump generator 102 may form or represent an actuator to pump or circulate (or recirculate) fluid through the fluid circulation channel 104. As such, fluid from the fluid feed slot 206 may circulate (or recirculate) through the channel section 202 of the fluid circulation channel 104, through the circulation loop 210, and the fluid ejection chamber 108 based on flow induced by the pump generator 102. As such, some of the fluid in the fluid circulation channel 104 may circulate (or recirculate) between the fluid feed slot 206 and the fluid ejection chamber 108 through the channel section 202 and the circulation loop 210. In one regard, circulating (or recirculating) fluid through the fluid ejection chamber 108 may help to reduce ink blockage and/or clogging in the fluid ejection device 200.

As illustrated in FIG. 2, the fluid ejection device 200 has a 1:1 nozzle-to-pump ratio, where the pump generator 102 may be referred to as a “pump” which induces fluid flow through the circulation loop 210. Other nozzle-to-pump ratios (e.g., 2:1; 3:1, 4:1, etc.) may also be possible, where one pump generator 102 may induce fluid flow through a fluid circulation channel communicated with multiple fluid ejection chambers and, therefore, multiple nozzles.

In the example illustrated in FIG. 2, the drop generator 106 and the pump generator 102 may be thermal resistors. Each of the thermal resistors may include, for example, a single resistor, a split resistor, a comb resistor, or multiple resistors. A variety of other devices, however, may also be used to implement the drop generator 106 and the pump generator 102 including, for example, a piezoelectric actuator, an electrostatic (MEMS) membrane, a mechanical/impact driven membrane, a voice coil, a magneto-strictive drive, and so on.

As shown in FIGS. 1 and 2, the fluid circulation channel 104 may be in fluid communication with the fluid ejection chamber 108 via the circulation loop 210. As such, a fluid housed in the fluid circulation channel 104 and the fluid ejection chamber 108 may be circulated, e.g., moved, through the fluid circulation channel 104 and the fluid ejection chamber 108 through activation of the pump generator 102 and/or the drop generator 106 beyond a threshold level. The threshold level of the pump generator 102 may correspond to a level at which the pump generator 102 causes a portion of the fluid in the fluid circulation channel 104 to reach a nucleation temperature, a boiling point temperature, or the like of the fluid. Likewise, the threshold level of the drop generator 106 may correspond to a level at which the drop generator 106 causes a portion of the fluid in the fluid ejection chamber 108 to reach a nucleation temperature, a boiling point temperature, or the like of the fluid.

Generally speaking, when the portion(s) of the fluid housed in the fluid circulation channel 104 and/or the fluid ejection chamber 108 reaches the nucleation temperature, the boiling point temperature, or the like of the fluid, a bubble (also referenced herein as a drive bubble) may be formed in the fluid. The formation of the bubble may increase the pressure inside of the fluid circulation channel 104 and/or the fluid ejection chamber 108, which may drive the fluid to flow through a portion of the fluid circulation channel 104 and/or the fluid ejection chamber 108. In some instances in which a bubble is formed in the fluid in the fluid circulation channel 104 without a bubble being formed in the fluid in the fluid ejection chamber 108, the fluid in the fluid ejection chamber 108 may not be ejected through the nozzle 112. In these instances, fluid may flow into the fluid ejection chamber 108 and/or the fluid circulation channel 104 from the fluid feed slot 206 or from the fluid feed slot 206 into the fluid ejection chamber 108 and/or the fluid circulation channel 104. The nucleation of the fluid in the fluid circulation channel 104 may thus cause the fluid in the fluid ejection chamber 108 and/or the fluid circulation channel 104 to be refreshed.

In instances in which a bubble is formed in the fluid ejection chamber 108, a portion of the fluid housed in the fluid ejection chamber 108 may be ejected through the nozzle 112 as a drop of the fluid. In these instances, following ejection of the drop of the fluid, additional fluid may be supplied back into the fluid ejection chamber 108, for instance, due to the decreased pressure inside of the fluid ejection chamber 108 resulting from the loss of the fluid volume inside of the fluid ejection chamber 108. The additional fluid may be supplied into the fluid ejection chamber 108 from the fluid circulation channel 104 and/or the fluid feed slot 206. As a result, the nucleation of the fluid in the fluid ejection chamber 108 may cause the fluid in the fluid ejection chamber 108 and/or the fluid circulation channel 104 to be refreshed.

As shown in FIG. 1, the apparatus 100 may include a controller 110 connected to the pump generator 102 and the drop generator 106 via a common control line 120. That is, for instance, the controller 110 may be connected to the pump generator 102 and the drop generator 106 via a common, single control line 120, in which the pump generator 102 may be in a parallel arrangement with respect to the drop generator 106. As a result, the controller 110 may not selectively activate the pump generator 102 and the drop generator 106 with respect to each other. Instead, the controller 110 may output common control signals as denoted by the arrows 122/124 to both of the pump generator 102 and the drop generator 106.

According to examples, at a first time, the controller 110 may output a first signal 122 to the control line 120, in which the first signal 122 may have a first pulse duration. In addition, at a second time, the controller 110 may output a second signal 124 to the control line 120, in which the second signal 124 may have a second pulse duration. The first signal 122 may correspond to a current that is applied across the pump generator 102 and the drop generator 106 for a first pulse duration. The second signal 124 may correspond to a current that is applied across the pump generator 102 and the drop generator 106 for a second pulse duration. The second pulse duration may be relative longer than the first pulse duration. In addition, the first pulse duration and the second pulse duration may be determined through testing, modeling, and/or the like.

Generally speaking, the first signal 122, e.g., the first pulse duration, and the second signal 124, e.g., the second pulse duration, may be tuned to various properties of the pump generator 102, the drop generator 106, the fluid to be housed in the fluid ejection device 200, and/or the like. Particularly, for instance, the first signal 122 may be tuned such that the output of the first signal 122 through the control line 120 may cause the pump generator 102 to form a drive bubble in the fluid circulation channel 104 without causing the drop generator 106 to form a drive bubble in the fluid ejection chamber 108. That is, the first signal 122 may cause both the pump generator 102 and the drop generator 106 to become heated, but the heating of the drop generator 106 may not result in the formation of a drive bubble in the fluid ejection chamber 108. In addition, the second signal 124 may be tuned such that the output of the second signal 124 through the control line 120 may cause the pump generator 102 to form a drive bubble in the fluid housed in the fluid circulation channel 104 and the drop generator 106 to form a drive bubble in the fluid housed in the fluid ejection chamber 108.

In some examples, the formation of a drive bubble in the fluid circulation channel 104 via the output of the first signal 122 or the formation of drive bubbles in both the fluid circulation channel 104 and the fluid ejection chamber 108 via the output of the second signal 124 may be achieved by causing the pump generator 102 and the drop generator 106 to have a different property with respect to each other. For instance, the pump generator 102 may have a first resistance level and the drop generator 106 may have a second resistance level, in which the second resistance level may differ from the first resistance level. By way of example, the first resistance level may be higher than the second resistance level, such that a current applied to the pump generator 102 at the first pulse duration may cause the bubble to be formed in a portion of the fluid contained in fluid circulation channel 104 without causing a bubble to be formed in the fluid ejection chamber 108. In addition, the first resistance level and the second resistance level may be levels that may cause bubbles to be formed in both the fluid circulation channel 104 and the fluid ejection chamber 108 when a current is applied to the control line 120 at the second pulse duration.

According to examples, the pump generator 102 may have a different physical property as compared with the drop generator 106, in which the physical property may cause the first resistance level to differ from the second resistance level. By way of example, the physical property may be the lengths of the pump generator 102 and the drop generator 106, in which the lengths may correspond to directions of current flow across the pump generator 102 and the drop generator 106. In addition, or alternatively, the physical property may be other dimensions of the pump generator 102 and the drop generator 106, e.g., the thicknesses, the widths, etc. In addition, or alternatively, the physical property may be materials of the pump generator 102 and the drop generator 106, e.g., the pump generator 102 may include a different material and/or a different combination of materials as compared with the drop generator 106.

With reference now to FIG. 3, there is shown an enlarged cross-sectional side view of a portion of the example fluid ejection device 200 depicted in FIG. 2. As shown, the fluid ejection device 200 may include a dividing layer 300 that may be positioned within the fluid circulation channel 104 and the fluid ejection chamber 108. The dividing layer 300 may include a first portion 302 and a second portion 304, in which the first portion 302 may be positioned adjacent the pump generator 102 and the second portion 304 may be positioned adjacent the drop generator 106. That is, the first portion 302 of the dividing layer 300 may be positioned between the pump generator 102 and an open space of the fluid circulation channel 104 and the second portion 304 of the dividing layer 300 may be positioned between the drop generator 106 and an open space of the fluid ejection chamber 108. The dividing layer 300 may keep a fluid 306 in the fluid ejection device 200 from directly contacting the pump generator 102 and the drop generator 106 and may thus protect the pump generator 102 and the drop generator 106 from the fluid 306. According to an example, the dividing layer 300 may be formed of silicon nitride and/or the like.

Although the dividing layer 300 is depicted as including separate portions 302, 304, it should be understood that the dividing layer 300 may instead be formed as a unitary layer. In addition, it should be understood that other components may be provided, e.g., formed, in the gaps between and outside of the fluid circulation channel 104 and the fluid ejection chamber 108. Moreover, an upper layer 310 may be provided to form the open spaces above the dividing layer 300 in which the fluid 306 may be housed. In some examples, the upper layer 310 may be formed of the same or similar material as the substrate 216, while in other examples, the upper layer 310 may be formed of a different material. By way of particular example, the upper layer 310 may be formed of silicon carbide and/or the like. In any of these examples, the nozzle 112 may be formed in the upper layer 310.

In addition to or alternatively to causing the pump generator 102 and the drop generator 106 to have a different property with respect to each other, the formation of a drive bubble in the fluid circulation channel 104 via the output of the first signal 122 or the formation of drive bubbles in both the fluid circulation channel 104 and the fluid ejection chamber 108 via the output of the second signal 124 may be achieved by causing the first portion 302 of the dividing layer 300 and the second portion 304 of the dividing layer 300 to have a different property with respect to each other. For instance, the first portion 302 may have a different thickness than the second portion 304 such that heat from the pump generator 102 may flow more readily through the first portion 302 than heat from the drop generator 106 through the second portion 304. That is, the first portion 302 may be thinner than the second portion 304. In addition or as another example, the first portion 302 may be formed of a different material than the second portion 304.

With reference back to FIG. 1, the controller 110 may output the first signal 122 onto the control line 120 in instances in which the fluid 306 is to be circulated in the fluid ejection device 200 without causing a drop of the fluid 306 to be ejected from the fluid ejection chamber 108. Thus, for instance, the first signal 122 may cause both the pump generator 102 and the drop generator 106 to be activated, but the first signal 122 may be of insufficient duration and/or strength to cause the drop generator 106 to cause a drive bubble to be formed in the fluid ejection chamber 108. In addition, the controller 110 may output the second signal 124 onto the control line 120 in instances in which a drop of fluid 306 is to be ejected from the fluid ejection chamber 108. The second signal 124 may cause the pump generator 102 to generate a drive bubble in the fluid circulation channel 104 and the drop generator 106 to generate a drive bubble in the fluid ejection chamber 108. Thus, for instance, the controller 110 may selectively cause a drive bubble to be generated in the fluid circulation channel 104 or both the fluid circulation channel 104 and the fluid ejection chamber 108.

According to examples, the controller 110 may include integrated circuitry, which may include a drive transistor such as a field-effect transistor (FET), for example. The FET may be associated with the pump generator 102 and the drop generator 106. In one example, the controller 110 may include a dedicated drive transistor for each pair of pump generators 102 and drop generators 106 in a fluid ejection device 200 to enable each of the pairs of pump generators 102 and drop generators 106 to be individually activated.

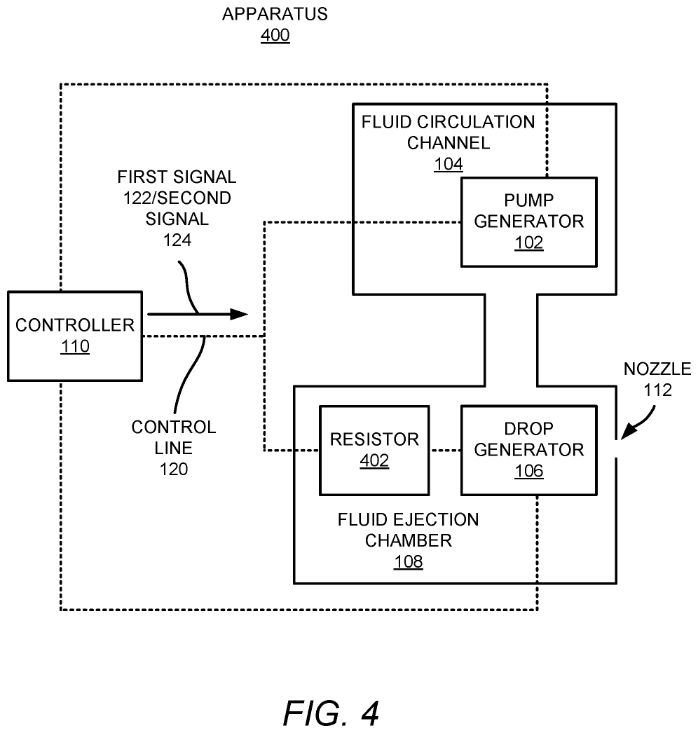

Turning now to FIG. 4, there is shown a block diagram of an example apparatus 400 that may include a pump generator 102 that may cause a portion of fluid to be circulated in a fluid circulation channel 104 and a drop generator 106 that may cause a portion of the fluid to be ejected from a fluid ejection chamber 108. It should be understood that the example apparatus 400 depicted in FIG. 4 may include additional features and that some of the features described herein may be removed and/or modified without departing from the scope of the apparatus 400.

The apparatus 400 may be equivalent to the apparatus 100 depicted in FIG. 1 and may include the fluid ejection device 200 depicted in FIGS. 2 and 3. The apparatus 400, however, may differ from the apparatus 100 in that the apparatus 400 may include a resistor 402 that may be positioned in series with the drop generator 106 and parallel with the pump generator 102. In this regard, the resistor 402 may reduce the current flow through the drop generator 106, which may the increase the duration of time that the drop generator 106 may receive the current to reach a temperature that may cause a drive bubble to be formed in a portion of the fluid in the fluid ejection chamber 108.

Thus, for instance, the resistor 402 may have a resistance level that may prevent the drop generator 106 from causing the fluid in the fluid ejection chamber 108 from reaching a nucleation temperature of the fluid during application of the first signal 122 across the drop generator 106. However, the resistance level of the resistor 402 may not prevent the drop generator 106 from causing the fluid in the fluid ejection chamber 108 from reaching the nucleation temperature of the fluid during application of the second signal 124 across the drop generator 106. In this regard, the resistance level of the resistor 402 may be tuned such that the resistor 402 may function as discussed herein with respect to the drop generator 106 and the fluid 306.

With reference now to FIG. 5, there is shown a block diagram of an example printing system 500 that may include either of the apparatuses 100, 400 depicted in FIGS. 1 and 4. The printing system 500 is depicted as including a printhead assembly 502, a fluid supply assembly 504, a mounting assembly 506, a media transport assembly 508, an external controller 510, and a power supply 512 that provides power to the various electrical components of the printing system 500. The printhead assembly 502 is also depicted as including a plurality of the apparatuses 100/400, e.g., which may be printheads, that may eject drops of fluid 306 through a plurality of orifices or nozzles 112 toward a print media 518 so as to print on the print media 518.

The print media 518 may be any type of suitable sheet or roll material, such as paper, card stock, transparencies, Mylar, and the like. The nozzles 112 may be arranged in one or more columns or arrays such that properly sequenced ejection of fluid from the nozzles 112 causes characters, symbols, and/or other graphics or images to be printed on print media 518 as the printhead assembly 502 and print media 518 are moved relative to each other.

The fluid supply assembly 504 may supply fluid to the printhead assembly 502 and, in one example, may include a reservoir 520 for storing fluid 306 such that fluid 306 flows from the reservoir 520 to the printhead assembly 502. The fluid supply assembly 504 and the printhead assembly 502 may form a one-way fluid delivery system or a recirculating fluid delivery system. In a one-way fluid delivery system, substantially all of the fluid supplied to the printhead assembly 502 is consumed during printing. In a recirculating fluid delivery system, only a portion of the fluid supplied to printhead assembly 502 is consumed during printing and fluid that is not consumed during printing may be returned to the fluid supply assembly 504.

In one example, the printhead assembly 502 and the fluid supply assembly 504 are housed together in an inkjet cartridge or pen. In another example, the fluid supply assembly 504 is separate from printhead assembly 502 and supplies fluid to the printhead assembly 502 through an interface connection, such as a supply tube. In either example, the reservoir 520 of fluid supply assembly 504 may be removed, replaced, and/or refilled. Where the printhead assembly 502 and the fluid supply assembly 504 are housed together in a cartridge, the reservoir 520 may include a local reservoir located within the cartridge as well as a larger reservoir located separately from the cartridge. The separate, larger reservoir may serve to refill the local reservoir. Accordingly, the separate, larger reservoir and/or the local reservoir may be removed, replaced, and/or refilled.

The mounting assembly 506 may position the printhead assembly 502 relative to the media transport assembly 508, and the media transport assembly 508 may position the print media 518 relative to the printhead assembly 502. Thus, a print zone 522 may be defined adjacent to the nozzles 112 in an area between the printhead assembly 502 and the print media 518. In one example, the printhead assembly 502 may be a scanning type printhead assembly. In this example, the mounting assembly 506 may include a carriage for moving the printhead assembly 502 relative to the media transport assembly 508 to scan across the print media 518. In another example, the printhead assembly 502 may be a non-scanning type printhead assembly. In this example, the mounting assembly 506 may fix the printhead assembly 502 at a prescribed position relative to the media transport assembly 508. Thus, the media transport assembly 508 may position the print media 518 relative to the printhead assembly 502.

The external controller 510 may include a processor, firmware, software, one or more memory components including volatile and non-volatile memory components, and other printer electronics for communicating with and controlling the printhead assembly 502, the mounting assembly 506, and the media transport assembly 508. The external controller 510 may receive data 524 from a host system, such as a computer, and may temporarily store the data 524 in a memory (not shown). The data 524 may be sent to the printing system 500 along an electronic, infrared, optical, or other information transfer path. The data 524 may represent, for example, a document and/or file to be printed. As such, the data 524 may form a print job for the printing system 500 and may include one or more print job commands and/or command parameters.

In one example, the external controller 510 may control the printhead assembly 502 for ejection of fluid drops from the nozzles 112. Thus, the external controller 510 may define a pattern of ejected fluid drops which form characters, symbols, and/or other graphics or images on the print media 518. The pattern of ejected fluid drops may be determined by the print job commands and/or command parameters.

The printhead assembly 502 may include a plurality of apparatuses (e.g., printheads) 100/400. In one example, the printhead assembly 502 is a wide-array or multi-head printhead assembly. In one implementation of a wide-array assembly, the printhead assembly 502 may include a carrier that may carry the plurality of apparatuses 100/400, provide electrical communication between the apparatuses 100/400 and the external controller 510, and provide fluidic communication between the apparatuses 100/400 and the fluid supply assembly 504. In some examples, the controllers 110 in the apparatuses 100/400 may, at various times, output either the first signal 122 or the second signal 124 to their respective control lines 120 based on receipt of instructions from the external controller 510.

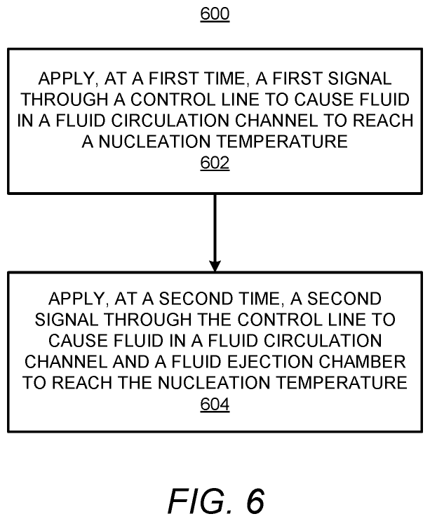

Various manners in which the apparatus 100/400 may operate are discussed in greater detail with respect to the method 600 depicted in FIG. 6. Particularly, FIG. 6 depicts a flow diagram of an example method 600 for selectively controlling the formation of a drive bubble in a fluid circulation channel 104 or drive bubbles in the fluid circulation channel 104 and a fluid ejection chamber 108. It should be understood that the method 600 depicted in FIG. 6 may include additional operations and that some of the operations described therein may be removed and/or modified without departing from the scope of the method 600. The description of the method 600 is made with reference to the features depicted in FIGS. 1-5 for purposes of illustration.

At block 602, the controller 110 may apply, at a first time, a first signal 122 through a control line 120 to a pump generator 102 in a fluid circulation channel 104 and a drop generator 106 in a fluid ejection chamber 108. As shown in FIGS. 1 and 2, the fluid ejection chamber 108 may be in fluid communication with the fluid circulation channel 104. As discussed herein, the first signal 122 may cause a portion of a fluid 306 in thermal communication with the pump generator 102 to reach or exceed a nucleation temperature of the fluid 306 without causing a portion of the fluid 306 in thermal communication with the drop generator 106 to reach the nucleation temperature.

That is, some of the fluid 306 in the fluid circulation channel 104, e.g., the portion of the fluid closest to the pump generator 102 may reach the nucleation temperature responsive to the pump generator 102 receiving the first signal 122. In addition, the fluid 306 in the fluid ejection chamber 108 may not reach the nucleation temperature responsive to the drop generator 106 receiving the first signal 122. In some examples, the controller 110 may apply the first signal 122 to the control line 120 to cause a portion of the fluid 306 included in the fluid ejection chamber 108 to be refreshed.

At block 604, the controller 110 may apply, at a second time, a second signal 124 through the control line 120 to the pump generator 102 and the drop generator 106. As discussed herein, the second signal 124 may cause the portions of the fluid 306 in thermal communication with the pump generator 102 and the drop generator 106 to reach the nucleation temperature of the fluid 306. In some examples, the controller 110 may apply the second signal 124 to the control line 120 to cause the portion of the fluid 306 included in the fluid ejection chamber 108 to be ejected as a droplet through a nozzle 112 in the fluid ejection chamber 108.

Some or all of the operations set forth in the method 600 may be included as utilities, programs, or subprograms, in any desired computer accessible medium. In addition, the method 600 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

For simplicity and illustrative purposes, the present disclosure is described by referring mainly to examples. In the foregoing description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a pump generator having a first resistance level and being positioned within a fluid circulation channel;
a drop generator having a second resistance level and being positioned within a fluid ejection chamber;
a control line connected to both the pump generator and the drop generator; and
a controller to:
output, at a first time, a first signal having a first pulse duration to the control line, the first signal to cause fluid in the fluid circulation channel to reach or exceed a first temperature and fluid in the fluid ejection chamber to remain below the first temperature; and
output, at a second time, a second signal having a second pulse duration to the control line, the second signal to cause fluid in the fluid circulation channel and the fluid ejection chamber to reach or exceed the first temperature.

2. The apparatus of claim 1, further comprising:
the fluid circulation channel and the fluid ejection chamber, wherein the fluid ejection chamber is in fluid communication with the fluid circulation channel and wherein a fluid is to be circulated through the fluid circulation channel and the fluid ejection chamber, and wherein the first temperature comprises a nucleation temperature of the fluid.

3. The apparatus of claim 2, wherein the controller is to output the first signal to cause the pump generator to create a drive bubble in a portion of the fluid positioned in thermal communication with the pump generator and circulate the fluid in the fluid circulation channel without causing a droplet of the fluid from being expelled through a nozzle in the fluid ejection chamber.

4. The apparatus of claim 2, wherein the first signal and the second signal correspond to currents applied across a first length of the pump generator and a second length of the drop generator, and wherein the first length corresponds to the first resistance level and the second length corresponds to the second resistance level.

5. The apparatus of claim 2, wherein:
the pump generator has a different thickness than the drop generator;
the pump generator is formed of a different material than the drop generator; and/or
a first portion of a dividing layer adjacent the pump generator has a different thickness than a second portion of the dividing layer adjacent the drop generator.

6. The apparatus of claim 1, wherein the control line is connected to the pump generator and the drop generator in a parallel arrangement.

7. The apparatus of claim 6, further comprising:
a resistor having a third resistance level, the control line being connected to the resistor, the resistor being connected to the drop generator along the control line in a series arrangement and to the pump generator along the control line in a parallel arrangement,
wherein the resistor is to prevent the fluid in the fluid ejection chamber reaching the first temperature responsive to the controller outputting the first signal to the control line.

8. A fluid ejection device comprising:
a fluid ejection chamber having a nozzle;
a fluid circulation channel in fluid communication with the fluid ejection chamber;
a drop generator positioned in the fluid ejection chamber;
a pump generator positioned in the fluid circulation channel;
a control line connected to the drop generator and the pump generator,
a first signal carried through the control line to cause the pump generator to heat fluid in the fluid circulation channel to or above a first temperature and fluid in the fluid ejection chamber to remain below the first temperature; and
a second signal carried through the control line to cause the pump generator to heat fluid in the fluid circulation channel and the drop generator to heat fluid in the fluid ejection chamber to or above the first temperature.

9. The fluid ejection device of claim 8, wherein the pump generator is to cause a drive bubble to be formed in a portion of fluid in thermal communication with the pump generator and wherein the drop generator is not to cause a drive bubble to be formed in a portion of fluid in thermal communication with the drop generator responsive to receipt of the first signal through the control line.

10. The fluid ejection device of claim 8, wherein the pump generator is to cause a drive bubble to be formed in a portion of fluid in thermal communication with the pump generator and the drop generator is to cause a drive bubble to be formed in a portion of fluid in thermal communication with the drop generator responsive to receipt of the second signal through the control line.

11. The fluid ejection device of claim 8, wherein the pump generator and the drop generator are connected to the control line in a parallel arrangement with respect to each other.

12. The fluid ejection device of claim 11, further comprising:
a resistor positioned in series with the drop generator and in parallel with the pump generator, the resistor to prevent the drop generator from reaching the first temperature responsive to receipt of the first signal.

13. The fluid ejection device of claim 8, wherein the pump generator has a first resistance level and the drop generator has a second resistance level, and wherein the first resistance level differs from the second resistance level.

14. A method comprising:
applying, at a first time, a first signal through a control line to a pump generator in a fluid circulation channel and a drop generator in a fluid ejection chamber, the fluid ejection chamber being in fluid communication with the fluid circulation channel, and the first signal to cause a portion of a fluid in thermal communication with the pump generator to reach or exceed a nucleation temperature of the fluid without causing a portion of the fluid in thermal communication with the drop generator to reach the nucleation temperature; and
applying, at a second time, a second signal through the control line to the pump generator and the drop generator, the second signal to cause the portions of the fluid in thermal communication with the pump generator and the drop generator to reach the nucleation temperature of the fluid.

15. The method of claim 14, further comprising:
applying the first signal to cause a portion of the fluid included in the fluid ejection chamber to be refreshed; and
applying the second signal to cause the portion of the fluid included in the fluid ejection chamber to be ejected as a droplet through a nozzle in the fluid ejection chamber.
